(19) United States
(12) Patent Application Publication
(10) Pub. No.: US 2002/0198476 A1
(43) Pub. Date: Dec. 26, 2002

(54) Exercise and massage device

(76) Inventor: Sherry Chen, Taichung (TW)

Correspondence Address: Sherry Chen, P.O. Box 63-99, Taichung, 406, TW

(21) Appl. No.: 09/888,700

(22) Filed: Jun. 22, 2001

(51) Int. Cl. A61H 7/00

(52) U.S. Cl. 601/84

(57) ABSTRACT

An exercise and massage device includes an elongate member made of rubber material for increasing the resilience and the flexibility of the elongate member, and for allowing the device to be used for rhythmic exercising purposes. A block may be selectively secured to one or both ends of the elongate member by such as threading with a fastener of the elongate member, for increasing the weights of the ends of the elongate member. The blocks may include different weights and may be selectively secured to the elongate member according to the strength of the users.

The present invention is related to U.S. patent application Ser. No. 09/837,933, filed on 18 Apr. 2001.

### BACKGROUND OF THE INVENTION

1. Field of the Invention

The present invention relates to an exercise device, and more particularly to an exercise and massage device.

2. Description of the Prior Art

One of the typical exercise and massage devices includes a number of flexible tongues and a grip attached to the middle portion of the flexible tongues for rhythmic exercise purposes. The flexible tongues may not be solidly retained in the grip and may be easily moved relative to the grip and may thus be easily disengaged from the grip.

The other typical exercise device and includes two handles attached to the ends of a short straight section of a helical wound cable. The helical wound cable has a bad resilience and thus may not be used for massage purposes or for rhythmical exercises. In addition, a number of elements are required to be manufactured and assembled by workers, such that the exercise device is not good for mass production.

The present invention has arisen to mitigate and/or obviate the afore-described disadvantages of the conventional exercise and massage devices.

### SUMMARY OF THE INVENTION

The primary objective of the present invention is to provide an exercise and massage device including a resilient and flexible structure having a greatly simplified configuration that is excellent for mass production and that may be made with less expenses.

The other objective of the present invention is to provide an exercise and massage device including one or more blocks that may be adjustably or selectively secured to an elongate member.

In accordance with one aspect of the invention, there is provided an exercise and massage device comprising an elongate body made of rubber material, the elongate body including at least one end, and one or more blocks selectively secured to the end of the elongate body. The elongate body may be easily and quickly made with a molding process and thus is good for mass production purposes.

One or more heads are further provided for receiving the blocks. The blocks may be a magnetic block. The blocks may include different volumes or weights and may be changeably or selectively secured onto the ends of the elongate body according to the strength of the users.

A device may further be provided for securing the block to the end of the elongate body and includes a fastener secured to the end of the elongate body for threading with and for securing to the block.

The block includes a screw hole formed therein for threading with the fastener. The head includes an orifice formed therein and aligned with the screw hole of the block. The heads may be used for striking onto the users or for massaging the users.

A device is further provided for retaining the fastener in the end of the elongate body and includes a tube secured in the end of the elongate body and having an aperture formed therein for receiving the fastener.

The tube includes an outer peripheral portion having at least one peripheral ear extended outward therefrom for solidly securing the tube in the elongate body.

The fastener includes a first end having an enlarged head formed thereon for engaging with the tube and for retaining the fastener in the elongate body and for preventing the fastener from being disengaged from the elongate body.

The fastener and/or the tube may be easily and quickly secured in the end of the elongate body during the molding processes. The blocks may also be easily and quickly secured in the enlarged heads respectively during the molding processes.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plane view illustrating the operation of an in accordance with the present invention;

FIG. 2 is a cross sectional view taken along lines 2-2 of FIG. 1;

FIG. 3 is an exploded and cross sectional view of the exercise and massage device; and

FIGS. 4, 5 are cross sectional views similar to FIG. 2 illustrating the other embodiments of the exercise and massage device.

### DETAILED DESCRIPTION OF THE PREFERRED EMBODIMENT

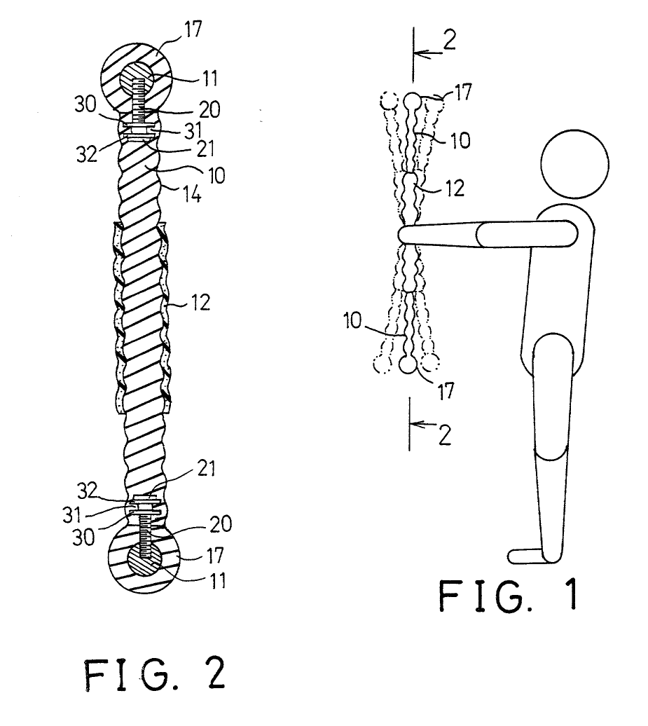

Referring to the drawings, and initially to FIGS. 1-3, an exercise and massage device in accordance with the present invention comprises an elongate body 10 made of rubber or composite or synthetic rubber materials having a suitable resilience and flexibility for allowing the elongate body 10 to be vibrated or swung by the user (FIG. 1). A hand grip 12 is preferably provided and engaged onto the outer peripheral portion of the elongate body 10 for grasping or gripping purposes, and may be extended along the whole length or a portion of the elongate body 10. The elongate body 10 and/or the hand grip 12 preferably includes a wavy outer peripheral surface 14 formed in the outer peripheral portion thereof for facilitating the grasping or the gripping or the flexibility of the exercise and massage device.

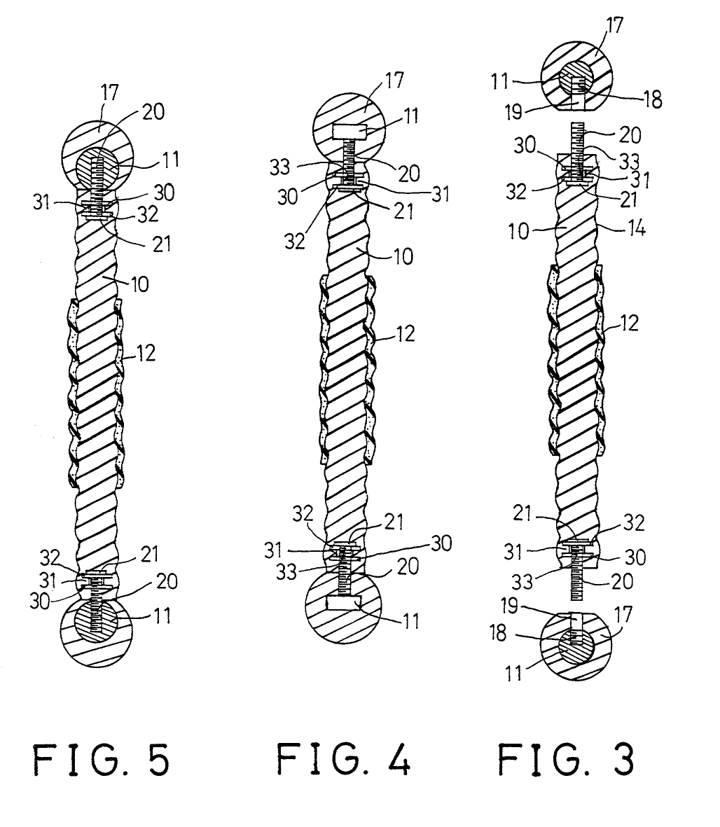

One or more enlarged heads 17 may further be provided on either or both of the ends of the elongate body 10, and may each include a block 11 engaged therein. The block 11 may include a cylindrical shape, or a spherical shape (FIGS. 2, 3), or a nut shape (FIG. 4), or the other shapes, and may be engaged in the middle or center portion of the enlarged head 17 (FIGS. 2, 3), or may be engaged in one end or in the peripheral portion of the enlarged head 17 (FIG. 5). The blocks 11 each includes a hole, such as a screw hole 18 formed therein, and the enlarged head 17 may include an orifice 19 formed therein and aligned with the hole 18 of the block 11.

The elongate body 10 includes one or both ends each having a fastener 20 secured therein and extended outward therefrom for threading with the screw holes 18 of the blocks 11, and for detachably or selectively securing to the blocks 11 respectively; or relatively, for detachably or selectively securing the blocks 11 to the ends of the elongate body 10, in order to selectively increase the weights of the ends of the elongate body 10.

A tube 30 may further be provided and engaged into each of the ends of the elongate body 10 and includes one or more peripheral recesses 31 formed in the outer peripheral portion thereof for forming or defining one or more peripheral ears 32 on the outer peripheral portion thereof, and for allowing the tubes 30 to be firmly or solidly secured in the elongate body 10. The tubes 30 each includes an aperture 33 formed therein for threading or receiving the respective fasteners 20. The fasteners 20 each includes an enlarged head 21 formed thereon and engaged with the tube 30 such that the fasteners 20 may be solidly secured to the elongate body 10 and will not be disengaged from the elongate body 10.

The elongate body 10 and/or the hand grip 12 may be formed by molding or mold-injection processes. The heads 17 may also be formed by a molding or a mold-injection process with the spongy or foamable materials, such as the poly urethane (PU). The fastener 20 and/or the tube 30 may be solidly engaged or secured in the elongate body 10 during the molding processes. The blocks 11 may also be easily and quickly formed into the enlarged heads 17 by the molding processes, and may be made by magnetic materials. The exerciser may include a number of heads 17 each having a block 11 secured therein. The blocks 11 may be made of different volumes or weights and may be selectively secured onto the ends of the elongate body 10 by the users according to the strength of the user.

In operation, as shown in FIG. 1, the user may hold the hand grip 12 to vibrate the elongate body 10 for rhythmic exercising purposes. The user may also hold one end of the elongate body 10 and use the enlarged head 17 provided on other end of the elongate body 10 to strike onto and to massage the user. The users may select the blocks 11 having the required or the suitable weights and may secure the blocks 11 onto the ends of the elongate body 10 according to the strength of the user.

Accordingly, the exercise and massage device in accordance with the present invention includes a resilient and flexible structure having a greatly simplified configuration that is excellent for mass production and that may be made with less expenses, and having one or more blocks that may be adjustably or selectively secured to an elongate member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An exercise and massage device comprising:
an elongate body made of rubber material, said elongate body including at least one end, and at least one block selectively secured to said at least one end of said elongate body.

2. The exercise and massage device according to claim 1 further comprising at least one head, said at least one block being engaged in said head.

3. The exercise and massage device according to claim 1, wherein said block is a magnetic block.

4. The exercise and massage device according to claim 1 further comprising means for securing said at least one block to said least one end of said elongate body.

5. The exercise and massage device according to claim 4, wherein said securing means includes a fastener secured to said at least one end of said elongate body for threading with and for securing to said at least one block.

6. The exercise and massage device according to claim 5, wherein said at least one block includes a screw hole formed therein for threading with said fastener.

7. The exercise and massage device according to claim 6 further comprising at least one head, said at least one block being engaged in said head.

8. The exercise and massage device according to claim 7, wherein said at least one head includes an orifice formed therein and aligned with said screw hole of said at least one block.

9. The exercise and massage device according to claim 5 further comprising means for retaining said fastener in said at least one end of said elongate body.

10. The exercise and massage device according to claim 9, wherein said retaining means includes a tube secured in said at least one end of said elongate body and having an aperture formed therein for receiving said fastener.

11. The exercise and massage device according to claim 10, wherein said tube includes an outer peripheral portion having at least one peripheral ear extended outward therefrom for solidly securing said tube in said elongate body.

12. The exercise and massage device according to claim 10, wherein said fastener includes a first end having an enlarged head formed thereon for engaging with said tube and for retaining said fastener in said elongate body.
